(19) United States
(12) Patent Application Publication
(10) Pub. No.: US 2025/0076261 A1
(43) Pub. Date: Mar. 6, 2025

(54) VIAL ADAPTER, SYSTEM AND METHOD

(71) Applicant: Waters Technologies Corporation, Milford, MA (US)

(72) Inventor: Sylvain Gilles Cormier, Mendon, MA (US)

(21) Appl. No.: 18/816,552

(22) Filed: Aug. 27, 2024

Related U.S. Application Data
(60) Provisional application No. 63/535,718, filed on Aug. 31, 2023.

(51) Int. Cl. G01N 30/18; B01D 15/14

(52) U.S. Cl. CPC G01N 30/18; B01D 15/14

(57) ABSTRACT

A sample vial adapter for use in liquid chromatography includes a body structure extending between a top end and a bottom end and defining a channel for receiving a sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial.

### RELATED APPLICATION

This application claims priority to U.S. provisional patent application No. 63/535,718 filed Aug. 31, 2024 and titled “Vial Adapter, System and Method” the entirety of which is incorporated by reference herein.

### FIELD OF THE INVENTION

The invention relates generally to liquid chromatography systems. More particularly, the invention relates to liquid chromatography sample managers, and associated systems and methods.

### BACKGROUND

Chromatography is a set of techniques for separating a mixture into its constituents. For instance, in a liquid chromatography system, a pump takes in and delivers a mixture of liquid solvents to a sample manager, where an injected sample awaits its arrival. In an isocratic chromatography system, the composition of the liquid solvents remains unchanged, whereas in a gradient chromatography system, the solvent composition varies over time. The mobile phase, comprised of a sample dissolved in a mixture of solvents, passes to a column, referred to as the stationary phase. By passing the mixture through the column, the various components in the sample separate from each other at different rates and thus elute from the column at different times. A detector receives the elution from the column and produces an output from which the identity and quantity of the analysis may be determined.

Prior to being provided into the liquid chromatography system, the sample may be provided to a sample manager. The sample manager may be configured to prevent the sample from degrading or becoming otherwise damaged while providing the sample into the liquid chromatography system. Sample managers are regularly interacted with by technicians and as such must be user friendly, dependable, accurate, reliable, serviceable, and cost effective.

Some sample managers are receptive to many sample vials disposable within a sample vial tray or carrier. Other sample managers require a technician to input individual vials. Such single-input sample managers may, for example, deploy a carousel system whereby a technician is provided access to a single location on the carousel for insertion of a new single vial. Due to the complexities of the carousel and the needle systems within the sample manager, such sample managers are generally capable of accepting vials of a single size and/or dimensional arrangement.

### SUMMARY

In one embodiment, a liquid chromatography system comprises: a solvent delivery system; a sample manager having a thermal chamber, the thermal chamber including a sample delivery system in fluidic communication with solvent delivery system, the sample delivery system including a sample needle, the sample delivery system configured to transfer a sample from a sample vial located in the thermal chamber into a chromatographic flow stream; a sample vial adapter having a body structure extending between a top end and a bottom end and defining a channel for receiving the sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial; a liquid chromatography column located downstream from the solvent delivery system and the sample delivery system; and a detector located downstream from the liquid chromatography column.

Additionally or alternatively, the body structure consists of a plastic material.

Additionally or alternatively the top end of the body structure includes a mock cap structure, wherein the mock cap structure is dimensioned to resemble a cap, the mock cap structure is an integral feature of the body structure, and/or the mock cap structure is not removable from the body structure. Further, the mock cap structure may include a top surface having an opening which provides a needle with access to the received sample vial.

Additionally or alternatively, the body structure further includes a back opening at a bottom of the channel, the back opening configured to provide access for a finger of a technician to press the received sample vial through the body structure to facilitate removal of the sample vial from the channel. Further, the body structure may include a second back opening configured to provide access for a second finger of the technician to press the received sample vial through the body structure to facilitate removal of the sample vial from the channel.

Additionally or alternatively, the body structure further includes a second extension at a same axial location as the extension, the second extension further reducing the width of the channel opening, the extension and the second extension forming a pair of extensions configured to hold the received sample vial within the channel. Further, the sample vial adapter may further include a second pair of extensions located at a different axial location as the pair of extensions.

Additionally or alternatively, the body structure forms a substantially cylindrical shape with the removed channel opening.

Additionally or alternatively, at least one of the body structure and the extension is configured to return to an original position after receiving the at sample vial and hold the received sample vial within the channel.

In another embodiment, a liquid chromatography sample manager comprises: a thermal chamber; a sample delivery system including a sample needle, the sample delivery system configured to transfer a first sample from a sample vial located in the thermal chamber into a chromatographic flow stream; and a sample vial adapter having a body structure extending between a top end and a bottom end and defining a channel for receiving a sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial, the at least one of the body structure and the extension configured to return to an original position after receiving the at sample vial and hold the received sample vial within the channel.

Additionally or alternatively, the body structure consists of a plastic material.

Additionally or alternatively the top end of the body structure includes a mock cap structure, wherein the mock cap structure is dimensioned to resemble a cap, the mock cap structure is an integral feature of the body structure, and/or the mock cap structure is not removable from the body structure. Further, the mock cap structure may include a top surface having an opening which provides a needle with access to the received sample vial.

Additionally or alternatively, the body structure further includes a back opening at a bottom of the channel, the back opening configured to provide access for a finger of a technician to press the received sample vial through the body structure to facilitate removal of the sample vial from the channel. Further, the body structure may include a second back opening configured to provide access for a second finger of the technician to press the received sample vial through the body structure to facilitate removal of the sample vial from the channel.

Additionally or alternatively, the body structure further includes a second extension at a same axial location as the extension, the second extension further reducing the width of the channel opening, the extension and the second extension forming a pair of extensions configured to hold the received sample vial within the channel. Further, the sample vial adapter may further include a second pair of extensions located at a different axial location as the pair of extensions.

Additionally or alternatively, the body structure forms a substantially cylindrical shape with the removed channel opening.

Additionally or alternatively, at least one of the body structure and the extension is configured to return to an original position after receiving the at sample vial and hold the received sample vial within the channel.

In another embodiment, a sample vial adapter for use in liquid chromatography comprises: a body structure extending between a top end and a bottom end and defining a channel for receiving a sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial.

Additionally or alternatively, the body structure consists of a plastic material.

Additionally or alternatively the top end of the body structure includes a mock cap structure, wherein the mock cap structure is dimensioned to resemble a cap, the mock cap structure is an integral feature of the body structure, and/or the mock cap structure is not removable from the body structure. Further, the mock cap structure may include a top surface having an opening which provides a needle with access to the received sample vial.

Additionally or alternatively, the body structure further includes a back opening at a bottom of the channel, the back opening configured to provide access for a finger of a technician to press the received sample vial through the body structure to facilitate removal of the sample vial from the channel. Further, the body structure may include a second back opening configured to provide access for a second finger of the technician to press the received sample vial through the body structure to facilitate removal of the sample vial from the channel.

Additionally or alternatively, the body structure further includes a second extension at a same axial location as the extension, the second extension further reducing the width of the channel opening, the extension and the second extension forming a pair of extensions configured to hold the received sample vial within the channel. Further, the sample vial adapter may further include a second pair of extensions located at a different axial location as the pair of extensions.

Additionally or alternatively, the body structure forms a substantially cylindrical shape with the removed channel opening.

Additionally or alternatively, at least one of the body structure and the extension is configured to return to an original position after receiving the at sample vial and hold the received sample vial within the channel.

In still another embodiment, a chromatography method comprises providing a liquid chromatography system including: a solvent delivery system; a sample manager having a thermal chamber, the thermal chamber including a sample delivery system in fluidic communication with solvent delivery system, the sample delivery system including a sample needle, the sample delivery system configured to transfer a sample from a sample vial located in the thermal chamber into a chromatographic flow stream; a sample vial adapter having a body structure extending between a top end and a bottom end and defining a channel for receiving the sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial; a liquid chromatography column located downstream from the solvent delivery system and the sample delivery system; and a detector located downstream from the liquid chromatography column. The method further includes providing the sample vial; inserting the sample vial into the sample vial adapter by elastically deforming the at least one of the extension and the body structure; inserting the sample vial adapter into the thermal chamber of the sample manager with the sample vial; interacting with the sample vial with the sample needle through the sample vial adapter; injecting the sample with the sample needle into the chromatographic flow stream; performing a separation on the sample with the liquid chromatography column; and detecting the sample with the detector.

Additionally or alternatively, the chromatography method may further include removing the sample vial adapter and the sample vial from the thermal chamber of the sample manager, removing the sample vial from the sample vial adapter, inserting a second sample vial into the sample vial adapter, inserting the sample vial adapter into the thermal chamber of the sample manager with the second sample vial, interacting with the second sample vial with the sample needle through the sample vial adapter, injecting the second sample with the sample needle into the chromatographic flow stream, performing a separation on the second sample with the liquid chromatography column and/or detecting the second sample with the detector.

In yet a further embodiment, a method of adapting a sample vial comprises: determining a circumference of a sample vial, wherein the sample vial is substantially cylindrical; determining a height of the sample vial; determining dimensions of an acceptable sample vial, wherein the acceptable sample vial is substantially cylindrical and has a larger circumference and height than the circumference and the height of the sample vial, wherein the acceptable sample vial is configured to be individually received and processed by an automated sample manager; and fashioning a sample vial adapter including a body structure extending between a top end and a bottom end and defining a channel for receiving the sample vial such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial, the at least one of the body structure and the extension configured to return to an original position after receiving the at sample vial and hold the received sample vial within the channel.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 depicts a schematic view of a liquid chromatography system including a sample manager in accordance with one embodiment.

FIG. 2 depicts a perspective view of a liquid chromatography system including the sample manager of FIG. 1 in accordance with one embodiment.

FIG. 3 depicts a sample vial, in accordance with one embodiment.

FIG. 4 depicts a perspective view of sample vial adapter, in accordance with one embodiment.

FIG. 5 depicts a perspective view of the sample vial adapter of FIG. 4 partially receiving the sample vial of FIG. 3, in accordance with one embodiment.

FIG. 6 depicts a perspective view of the sample vial of FIG. 3 received by the sample vial of FIG. 4, in accordance with one embodiment.

FIG. 7 depicts a method of adapting a sample vial, in accordance with one embodiment.

FIG. 8 depicts a chromatographic method, in accordance with one embodiment.

FIG. 9 depicts a further chromatographic method, in accordance with one embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

As described herein, prior to performing a liquid chromatography run, a technician loads a vial containing a sample into a sample manager receptacle or receiver of individual sample vials. The sample manager system includes a sample delivery system that is configured to transfer the sample from the sample-vial carrier into a chromatographic flow stream. The thermal chamber includes sampling mechanism which includes a rotating sample vial carousel in order to process samples that have been provided to the receptacle or receiver. At least one sampling needle as a part of the sampling mechanism is located within and/or that can access the thermal chamber which can draw a sample from the vial and inject the sample into a chromatographic flow stream. As contemplated herein, the sample manager and sample delivery system, along with the carousel thereof, may be particularly configured for a sample vial of an acceptable, preferred and/or specifically defined dimension. Because of engineering complexities in both the carousel, sensors, and needle design, such systems may not be configured for sample vials having different dimensions than the acceptable, preferred and/or specifically defined dimension. However, sample vials having dimensions that are different than the acceptable, preferred and/or specifically defined dimension may be desired to be processed by such a configured sample manager. In such instances, the present embodiments contemplate altering the dimensions of the different sample vial with a sample vial adapter in order to enable processing by a sample manager which would not otherwise be configured to process the different sample vial due to the different dimensions. While embodiments described herein may be particularly applicable to a single-load sample vial system having a carousel system, applying sample vial adapters as described herein may be applicable to any system where it would be desirable to alter the dimensions of a sample vial for the purpose of facilitating an automation system interacting with the sample vial.

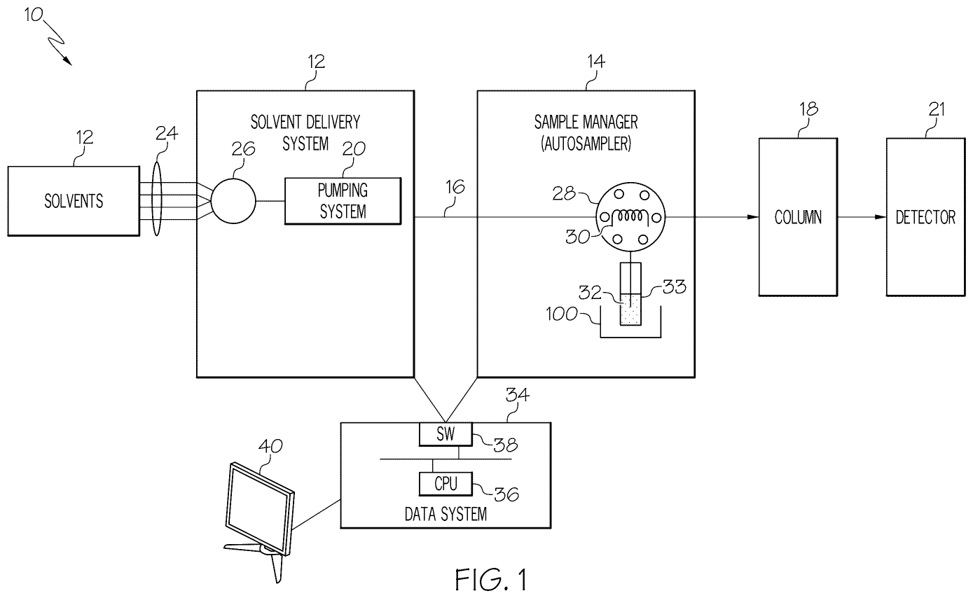

The features of the sample delivery system and sample manager thermal chamber described herein may be applicable to any liquid chromatography system configured to deliver samples into a chromatographic flow stream. As one example, FIG. 1 shows an embodiment of a liquid chromatography system 10 for separating a mixture into its constituents. The liquid chromatography system 10 includes a solvent delivery system 12 in fluidic communication with a sample manager 14 (also called an injector or an autosampler) through tubing 16. The sample manager 14 is in fluidic communication with a chromatographic column 18. A detector 21 for example, a mass spectrometer, is in fluidic communication with the column 18 to receive the elution.

The solvent delivery system 12 includes a pumping system 20 in fluidic communication with solvent reservoirs 22 from which the pumping system 20 draws solvents (liquid) through tubing 24. In one embodiment, the pumping system 20 is embodied by a mixing system having one or more pumps. The liquid chromatography system 10 may be an ultra-performance liquid chromatography (UPLC) system, for example, although the invention is not limited to this embodiment. For example, in a low-pressure gradient pumping system, the mixing of solvents occurs before the pump, and the solvent delivery system 12 has a mixer 26 in fluidic communication with the solvent reservoirs 22 to receive various solvents in metered proportions. This mixing of solvents (mobile phase) composition that varies over time (i.e., in a gradient). However, in other embodiments, mixing may occur after the pumping system 20 but prior to providing the chromatography flow to the sample manager 14.

The pumping system 20 is shown in fluidic communication with the mixer 26 to draw a continuous flow of gradient therefrom for delivery to the sample manager 14. Examples of solvent delivery systems that can be used to implement the solvent delivery system 12 include, but are not limited to, the ACQUITY Binary Solvent Manager and the ACQUITY Quaternary Solvent Manager, manufactured by Waters Corp. of Milford, Mass.

The sample manager 14 may include an injector valve 28 having a sample loop 30. The sample manager 14 may operate in at least two states: a load state and an injection state. In the load state, the position of the injector valve 28 is such that the sample manager loads the sample 32 into the sample loop 30. The sample 32 is drawn from a vial contained by a sample vial carrier. “Sample vial carrier” herein means any device configured to carry a sample vial such as a well plate, sample vial carrier, or the like. In the injection state, the position of the injector valve 28 changes so that the sample manager 14 introduces the sample in the sample loop 30 into the continuously flowing mobile phase from the solvent delivery system. The mobile phase thus carries the sample into the column 18. In other embodiments, a flow through needle (FTN) may be utilized instead of a Fixed-Loop sample manager. Using an FTN approach, the sample may be pulled into the needle and then the needle may be moved into a seal. The valve may then be switched to make the needle in-line with the solvent delivery system.

The liquid chromatography system 10 further includes a data system 34 that is in signal communication with the solvent delivery system 12 and the sample manager 14. The data system 34 has a processor 36 and a switch 38 (e.g. an Ethernet switch) for handling signal communication between the solvent delivery system 12 and sample manager 14, as described herein. Signal communication among the various systems and instruments can be electrical or optical, using wireless or wired transmission. A host computing system 40 is in communication with the data system 34 by which a technician can download various parameters and profiles (e.g., an intake velocity profile) to the data system 34.

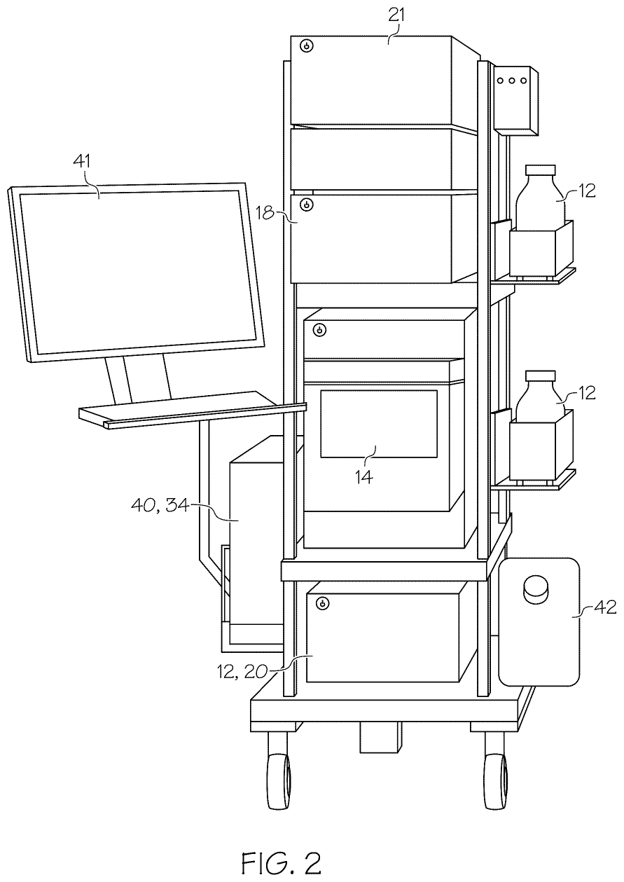

FIG. 2 shows a perspective view of the liquid chromatography system 10 including the sample manager 14, the detector 21, the chromatographic column 18, the solvent delivery system 12 and pump system 20, and the solvents 22. Each of the sample manager 14, the detector 21, the chromatographic column 18, the solvent delivery system 12 may include a housing or body within which the various features may be housed. Further, the entire liquid chromatography system 10 is connected to the data system 34 (e.g. a computer system) which includes a user interface and/or display device 41. The various components 12, 14, 18, 19, 21, 22 of the liquid chromatography system 10 may be interconnected with fluidic tubes and in signal communication to the data system 34 and/or the host computing system 40 of the system. The liquid chromatography system 10 is shown with the solvent delivery system 12, sample manager 14, chromatographic column 18, detector 21 and multiple trays for holding the solvents 22, as well as a waste container 42. The liquid chromatography system 10 may be a PATROL UPLC system, for example, manufactured by Waters Corp. of Milford, Mass.

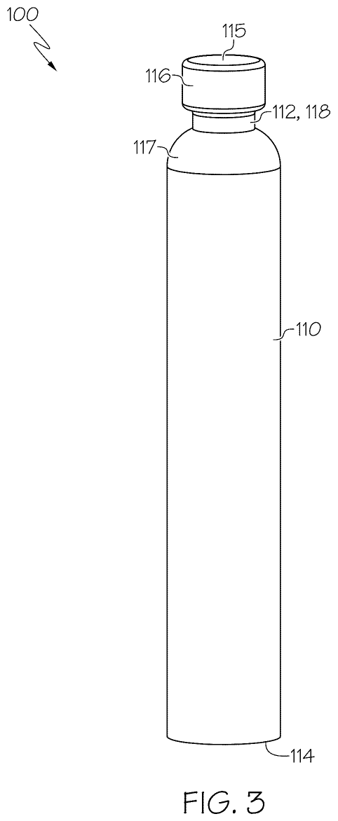

FIG. 3 depicts a sample vial 100, in accordance with one embodiment. The sample vial 100 includes a main body 110 extending between a top end 112 and a bottom end 114. Proximate the top end 114, the sample vial 100 further includes a cap 116. The cap 116 may be threadably engaged or crimped with the main body 110 of the sample vial 100. In other embodiments, the cap 116 may be attached to the main body 110 with a press fit or interference fit, for example. The cap 116 may include a top structure 115 which may be configured to retain the sample within the sample vial 100 but may also be thin enough to be pierced by a sample needle (not shown) from the sample manager 14.

The main body 110 of the sample vial 100 may be generally cylindrical in shape. The top end 114 of the generally cylindrical main body 110 may include a narrowing or tapering portion 117. A neck 118 extends from the narrowing or tapering portion 117. The neck 118 may include external threads for receiving the internal threads of the cap 116 in a threadable arrangement.

The dimensions of the sample vial 100 shown are exemplary, and the principles of the embodiments described herein may be applicable to any sample vial structure having a generally cylindrical, or cylindrical main body. In other embodiments, various dimensions of the sample vial may differ such as the height of the sample vial, the circumference of the main body, the shape of the top end 112 (i.e. the shape or taper of the narrowing portion 117 and the dimensions of the neck 118), the height or circumference of the cap 116, or the like. In some embodiments, the sample vial may not include a tapered portion or neck, and may simply include the cylindrical main body extending to a threaded end for receiving a cap. Whatever the embodiment, the present invention contemplates fashioning a sample vial adapter to match and/or correspond to the dimensions of the sample vial 100, as described herein below.

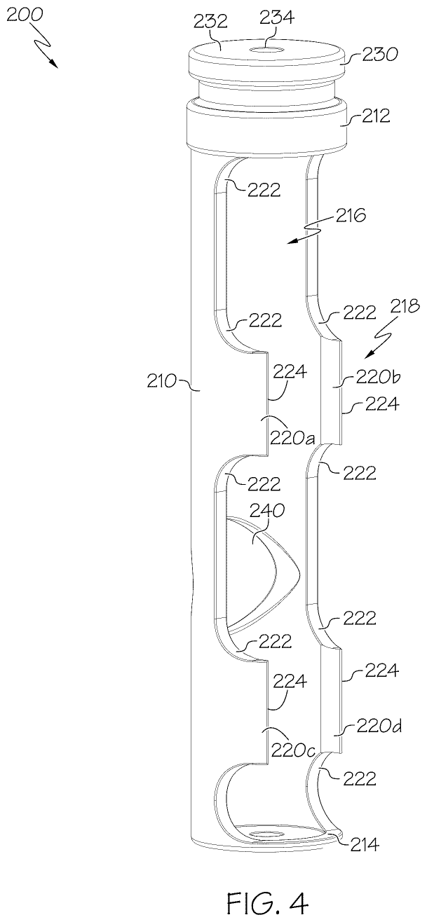

FIG. 4 depicts a perspective view of sample vial adapter 200, in accordance with one embodiment. The sample vial adapter 200 includes a body structure 210 extending between a top end 212 and a bottom end 214. The body structure 210 defines a channel 216 for receiving the sample vial 100. While a specific channel dimension has been shown for the channel 216 to adapt for the dimensions of the sample vial 100, other channel dimensions are contemplated in order to adapt to sample vials of different sizes and dimensions.

In any event, the channel 216 may be dimensioned to at least partially encircles the received sample vial 100. The channel 216 may extend the majority of the length of the body structure 210 from the top end 212 to the bottom end 214. The channel 216 may wrap about 180 degrees around the sample vial 100. In some embodiments, the channel 216 may wrap more or less than 180 degrees around the sample vial 100.

The body structure 210 includes a channel opening 218 configured to receive the sample vial 100 within the channel 216. The body structure 210 further includes a plurality of extensions 220a, 220b, 220c, 220d reducing a width of the channel opening 218. The extensions 220a, 220b, 220c, 220d are shown including curved extending edges 222 which extend the extensions 220a, 220b, 220c, 200d into the channel opening 218. The extensions 220a, 220b, 220c, 220d maintain the curvature of the circumference of the channel 216 and body structure 210, and extend to a flat axially extending edge 224. In other embodiments, the extensions 220a, 220b, 220c, 220d may be curved slightly inward so that a received vial will be retained in the channel 216 with a constant biasing force provided by the extensions 220a, 220b, 220c, 220d.

Whatever the embodiment, the first and second extensions 220a, 220b may form a first pair of extensions located at a first axial position of the body structure 210 while the third and the fourth extensions 220c, 220d may form a second pair of extensions located at a second axial position of the body structure that is lower than the first axial position. Any number of extension pairs are contemplated. For example, the body structure 210 may include a single pair of extensions, or may include more than two pairs of extensions. In some cases, the body structure 210 may not use extension pairs, but may include a single flexible extension extending from only a single side of the channel opening 218.

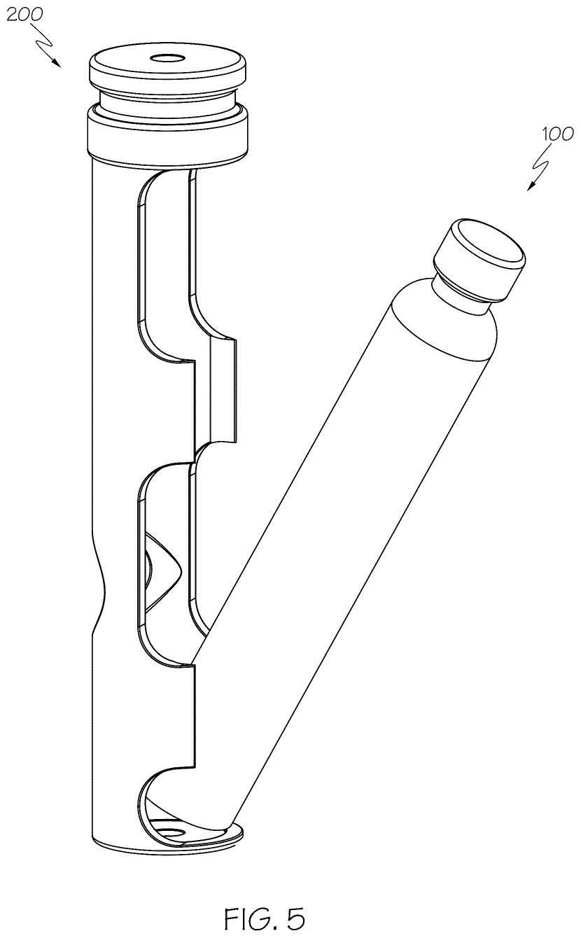

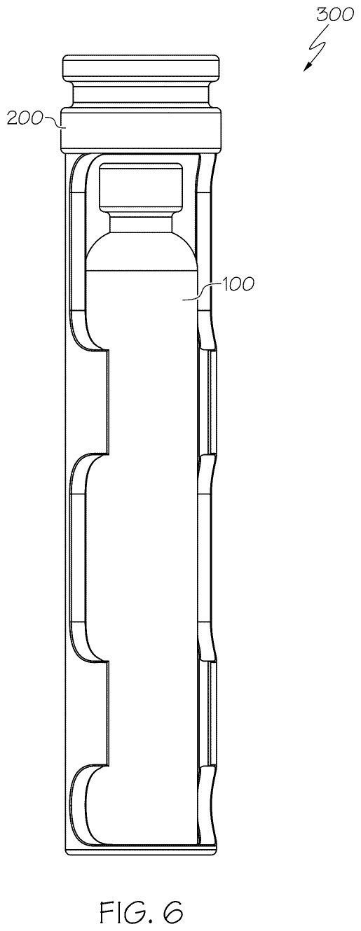

Each of the extensions 220a, 220b, 220c, 220d and/or the body structure 210 may be configured to elastically deform and/or deflect during the process of receiving the sample vial 100. This process is shown more clearly in FIGS. 5-6. Once received, the extensions 220a, 220b, 220c, 220d and/or the body structure 210 may be configured to return to an original position (i.e. as shown in FIG. 4) after receiving the at sample vial 100 and hold the received sample vial 100 within the channel 216. To accomplish this deflection or elastic deformation, the body structure of the sample vial adapter 200 may be made of a plastic material, a polymer, a composite, or even a flexible metallic material, for example. Whatever the material, the flexibility should be such that the extensions 220a, 220b, 220c, 220d may flex when receiving the sample vial 100, and allow for the sample vial 100 to snap into place within the channel 216 via, for example, a snap-fit, after which the sample vial 100 remains securely in the channel 216 until purposefully removed. Removal may require the extensions to once again be flexed or elastically deformed in order to allow for the sample vial 100 to be removed.

In some embodiments it is contemplated that a sample vial received in the channel 216 via a snap-fit may retain some small degree of outwardly flexing force on the extensions 220a, 220b, 220c, 220d. For example, the sample vial 100 may be large enough in circumference or dimension to extend into the space occupied by the original position of the extensions 220a, 220b, 220c, 220d when the sample vial 100 is received in the channel 216.

The top end 212 of the body structure 210 includes a mock cap structure 230. The mock cap structure 230 may be dimensioned to resemble an actual cap. However, the mock cap structure 230 may instead be an integral feature of the body structure 210 and may not be removable from the body structure 210. The mock cap structure 230 includes a top surface 232 having an opening 234. The opening 234 may be configured to provide a sample needle or injector needle with access to the received sample vial 100.

The body structure 210 further includes a back opening 240 at a bottom of the channel 216. The back opening 240 may be configured to provide access for a finger of a technician to press the received sample vial 100 through the body structure 210 to facilitate removal of the sample vial 210 from the channel 216 and the body structure 210. While a single opening is contemplated as shown in the Figures, in other embodiments, more than one back opening may be included. For example, the body structure 210 may include a second back opening that is configured to provide access for a second finger of the technician to press the received sample vial 100 through the body structure 210 to facilitate removal of the sample vial 100 from the channel 216 and the body structure 210.

The body structure 210 forms a substantially cylindrical shape with the removed channel opening 216. This shape may be configured to simulate, represent or replicate an acceptable, preferred and/or standard shape of a sample vial configured for a specific sample manager system. The acceptable, preferred and/or standard shape of the sample vial may be a shape that is specifically dimensioned to be acceptable by a sample vial carrier system, needle design and sensor system of a sample manager that has been specifically configured to be optimized for this acceptable or preferred shape and dimension. While the embodiment contemplated shows one example of an acceptable or preferred shape, the body structure 210 may take other shapes depending on the designs of a corresponding sample manager system.

FIG. 5 depicts a perspective view of the sample vial adapter 200 of FIG. 4 partially receiving the sample vial 100 of FIG. 3, in accordance with one embodiment. As shown, the bottom of the sample vial 100 is shown being first inserted into the sample vial adapter 200. Once this occurs the top of the sample vial 100 may be pressed into the sample vial adapter 200, deflecting the body structure 210 and/or the extensions 220a, 220b, 220c, 220d of the sample vial adapter 200 in order to snap the sample vial 100 into place received within the channel 216. FIG. 6 depicts a perspective view of the sample vial of FIG. 3 received by the sample vial of FIG. 4, in accordance with one embodiment.

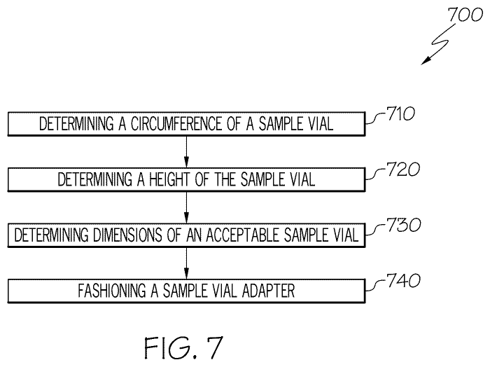

FIG. 7 depicts a method 700 of adapting a sample vial, such as the sample vial 100, in accordance with one embodiment. The method 700 may include a first step 710 of determining a circumference of a sample vial, such as the sample vial 100. The sample vial 100 may be substantially cylindrical. The method 700 may include another step 720 of determining a height of the sample vial.

The method 700 may then include a step 730 of determining the dimensions of an acceptable sample vial for a given sample manager. These dimensions may be well known and may represent the dimensions of a standard sample vial that is configured for use with a given automated sample manager and may further be configured to be individually received and processed by the sample manager. The acceptable sample vail may also be substantially cylindrical in shape and may have both a larger circumference and height than the circumference and the height of the sample vial of steps 710, 720.

The method 700 then includes a step of fashioning a sample vial adapter, such as the sample vial adapter 200. The sample vial adapter may be fashioned to include a body structure, such as the body structure 210, extending between a top end and a bottom end and defining a channel, such as the channel 216, for receiving the sample vial such that the channel at least partially encircles the received sample vial. The body structure 210 may further be fashioned to include a channel opening 218 configured to receive the sample vial. The body structure may further be fashioned to include an extension reducing a width of the channel opening, where either or both of the extension and the body structure are configured to elastically deform during the process of receiving the sample vial and then return to an original position after receiving the at sample vial and hold the received sample vial within the channel.

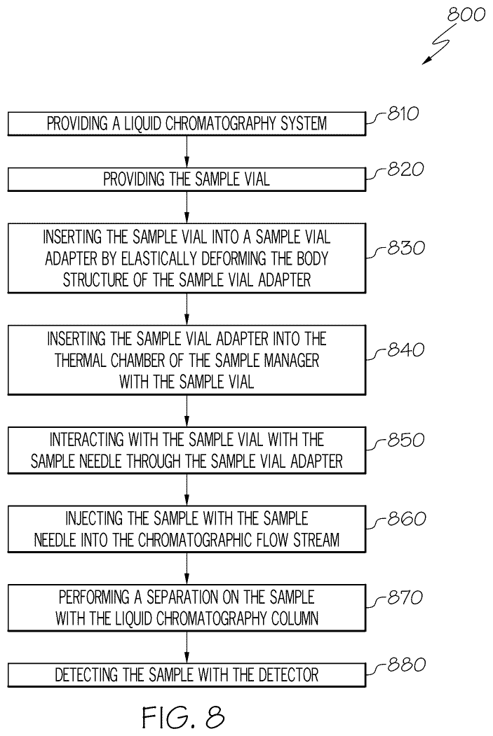

Methods contemplated further include utilizing the sample vial adapter in a chromatographic method, such as within the liquid chromatography system 10 in order to separate and detect samples. FIG. 8 depicts a chromatographic method 800, in accordance with one embodiment. The chromatographic method 800 includes a step 810 of providing a liquid chromatography system, such as the liquid chromatography system 10. The method 800 includes a step 820 of providing a sample vial, such as the sample vial 100. The method 800 includes a step 830 of inserting the sample vial into a sample vial adapter, such as the sample vial adapter 200, by elastically deforming the body structure of the sample vial adapter. The method 800 then includes a step 840 of inserting the sample vial adapter into the thermal chamber of the sample manager with the sample vial. The method 800 includes a step 850 of interacting with the sample vial with the sample needle through the sample vial adapter and a step 860 of injecting the sample with the sample needle into the chromatographic flow stream. The method 800 then includes a step 870 of performing a separation on the sample with a liquid chromatography column, such as the column 18, and a step 880 of detecting the sample with a detector, such as the detector 21.

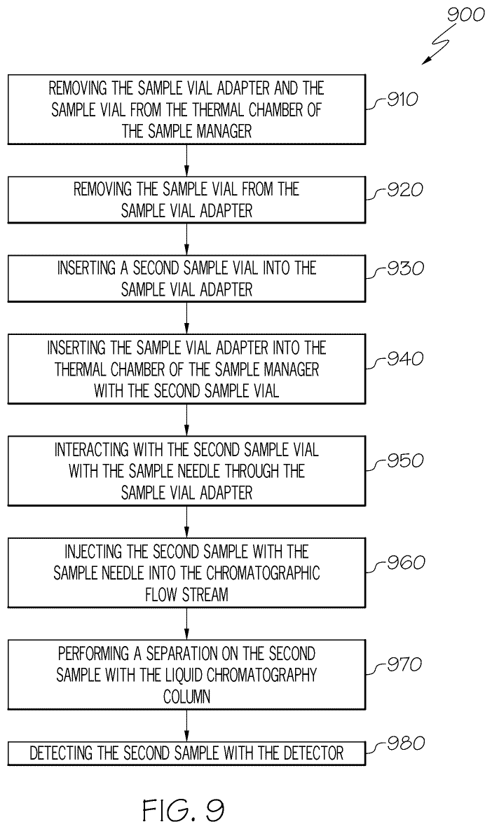

FIG. 9 depicts a further chromatographic method 900, in accordance with one embodiment. The method 900 may be a continuation of the method 800 described herein above. The method 900 includes a first step 910 of removing the sample vial adapter and the sample vial from the thermal chamber of the sample manager. The method 900 then includes a step 920 of removing the sample vial from the sample vial adapter. The method 900 then includes a step 930 of inserting a second sample vial into the sample vial adapter. The second sample vial may have the same dimensions as the first sample vial, but may include its own different sample within. The method 900 may then include a step 940 of inserting the sample vial adapter into the thermal chamber of the sample manager with the second sample vial, and a step 950 of interacting with the second sample vial with the sample needle through the sample vial adapter. The method 900 may then include a step 960 of injecting the second sample with the sample needle into the chromatographic flow stream. Finally, the method 900 may include a step 970 of performing a separation on the second sample with the liquid chromatography column, and a step 980 of detecting the second sample with the detector.

While the invention has been shown and described with reference to specific embodiments, it should be understood by those skilled in the art that various changes in form and detail may be made therein without departing from the spirit and scope of the invention as recited in the accompanying claims.

What is claimed is:

1. A liquid chromatography system comprising:
a solvent delivery system;
a sample manager having a thermal chamber, the thermal chamber including a sample delivery system in fluidic communication with solvent delivery system, the sample delivery system including a sample needle, the sample delivery system configured to transfer a sample from a sample vial located in the thermal chamber into a chromatographic flow stream;
a sample vial adapter having a body structure extending between a top end and a bottom end and defining a channel for receiving the sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial;
a liquid chromatography column located downstream from the solvent delivery system and the sample delivery system; and
a detector located downstream from the liquid chromatography column.

2. The liquid chromatography system of claim 1, wherein the body structure consists of a plastic material.

3. The liquid chromatography system of claim 1, wherein the top end of the body structure includes a mock cap structure, wherein the mock cap structure is dimensioned to resemble a cap, wherein the mock cap structure is an integral feature of the body structure, wherein the mock cap structure is not removable from the body structure.

4. The liquid chromatography system of claim 3, wherein the mock cap structure includes a top surface having an opening, wherein the opening provides a needle with access to the received sample vial.

5. The liquid chromatography system of claim 1, wherein the body structure further includes a back opening at a bottom of the channel, the back opening configured to provide access for a finger of a technician to press the received sample vial through the body structure to facilitate removal of the sample vial from the channel.

6. The liquid chromatography system of claim 5, wherein the body structure includes a second back opening, the second back opening configured to provide access for a second finger of the technician to press the received sample vial through the body structure to facilitate removal of the sample vial from the channel.

7. The liquid chromatography system of claim 1, wherein the body structure further includes a second extension at a same axial location as the extension, the second extension further reducing the width of the channel opening, the extension and the second extension forming a pair of extensions configured to hold the received sample vial within the channel.

8. The liquid chromatography system of claim 7, the sample vial adapter further including a second pair of extensions located at a different axial location as the pair of extensions.

9. The liquid chromatography system of claim 1, wherein the body structure forms a substantially cylindrical shape with the removed channel opening.

10. The liquid chromatography system of claim 1, wherein at least one of the body structure and the extension is configured to return to an original position after receiving the at sample vial and hold the received sample vial within the channel.

11. A liquid chromatography sample manager comprising:
a thermal chamber;
a sample delivery system including a sample needle, the sample delivery system configured to transfer a first sample from a sample vial located in the thermal chamber into a chromatographic flow stream; and
a sample vial adapter having a body structure extending between a top end and a bottom end and defining a channel for receiving a sample vial having a cylindrical sample vial body such that the channel at least partially encircles the received sample vial, the body structure including a channel opening configured to receive the sample vial, the body structure including an extension reducing a width of the channel opening, at least one of the extension and the body structure configured to elastically deform during the process of receiving the sample vial.

12. The liquid chromatography sample manager of claim 11, wherein the top end of the body structure includes a mock cap structure, wherein the mock cap structure is dimensioned to resemble a cap, wherein the mock cap structure is an integral feature of the body structure, wherein the mock cap structure is not removable from the body structure.

13. The liquid chromatography sample manager of claim 12, wherein the mock cap structure includes a top surface having an opening, wherein the opening provides a needle with access to the received sample vial.

14. The liquid chromatography sample manager of claim 11, wherein the body structure further includes a back opening at a bottom of the channel, the back opening configured to provide access for a finger of a technician to press the received sample vial through the body structure to facilitate removal of the sample vial from the channel.

15. The liquid chromatography sample manager of claim 14, wherein the body structure includes a second back opening, the second back opening configured to provide access for a second finger of the technician to press the received sample vial through the body structure to facilitate removal of the sample vial from the channel.

16. The liquid chromatography sample manager of claim 11, wherein the body structure further includes a second extension at a same axial location as the extension, the second extension further reducing the width of the channel opening, the extension and the second extension forming a pair of extensions configured to hold the received sample vial within the channel.

17. The liquid chromatography sample manager of claim 16, the sample vial adapter further including a second pair of extensions located at a different axial location as the pair of extensions.

18. The liquid chromatography sample manager of claim 11, wherein at least one of the body structure and the extension is configured to return to an original position after receiving the at sample vial and hold the received sample vial within the channel.

19. A chromatographic method comprising:
providing the liquid chromatography system of claim 1;
providing the sample vial;
inserting the sample vial into the sample vial adapter by elastically deforming the at least one of the extension and the body structure;
inserting the sample vial adapter into the thermal chamber of the sample manager with the sample vial;
interacting with the sample vial with the sample needle through the sample vial adapter;
injecting the sample with the sample needle into the chromatographic flow stream;
performing a separation on the sample with the liquid chromatography column; and
detecting the sample with the detector.

20. The chromatographic method of claim 19, further comprising:
removing the sample vial adapter and the sample vial from the thermal chamber of the sample manager;
removing the sample vial from the sample vial adapter;
inserting a second sample vial into the sample vial adapter;
inserting the sample vial adapter into the thermal chamber of the sample manager with the second sample vial;
interacting with the second sample vial with the sample needle through the sample vial adapter;
injecting the second sample with the sample needle into the chromatographic flow stream;
performing a separation on the second sample with the liquid chromatography column; and
detecting the second sample with the detector.
